(19) United States
(12) Patent Application Publication
(10) Pub. No.: US 2026/0111716 A1
(43) Pub. Date: Apr. 23, 2026

(54) ARTIFICIAL NEURAL NETWORK TRAINING AND PREDICTION METHOD BASED ON CLUSTERING

(71) Applicant: ELECTRONICS AND TELECOMMUNICATIONS RESEARCH INSTITUTE, Daejeon (KR)

(72) Inventor: Yo Han Lee, Daejeon (KR)

(21) Appl. No.: 19/250,622

(22) Filed: Jun. 26, 2025

(30) Foreign Application Priority Data
Oct. 21, 2024 (KR) 10-2024-0143818

(51) Int. Cl. G06N 3/0499; G06N 3/047; G06N 3/088

(52) U.S. Cl. CPC G06N 3/0499; G06N 3/047; G06N 3/088

(57) ABSTRACT

Disclosed is an artificial neural network training and prediction method based on clustering. The artificial neural network training method based on clustering includes obtaining a predicted cluster probability distribution indicating a probability that input data will belong to each of multiple cluster classes and a target cluster probability distribution indicating a probability that output data, which is a label for the input data, will belong to each of the multiple cluster classes, and training the artificial neural network to minimize a loss function including cross-entropy between the predicted cluster probability distribution and the target cluster probability distribution.

### CROSS-REFERENCE TO RELATED APPLICATION

The present application claims priority to and the benefit of Korean Patent Application No. 10-2024-0143818, filed on Oct. 21, 2024, in the Korean Intellectual Property Office, the entire disclosure of which is incorporated herein by reference.

### BACKGROUND

### 1. Field of the Invention

The present disclosure relates to an artificial neural network training and prediction method based on clustering.

### 2. Description of Related Art

Learning (training) methods for artificial neural networks, which are represented by deep learning, are generally classified into supervised learning, unsupervised learning, and reinforcement learning. In order to train an artificial neural network using supervised learning, a pair of input data and output data is required. For example, in a task for recognizing objects within an image, the input data may be an image containing objects desired to be recognized (e.g., a picture of a dog or a cat), and the output data may be a label to the input image (e.g., dog, cat, or the like).

In the case of a sequence prediction task for natural language generation, when a word sequence is composed of words from step 1 to step T, the input data is a word sequence from step 1 to step T-1, and the output data is a word sequence from step 2 to step T. Although such a sequence prediction task is known as an unsupervised learning method, the present disclosure treats this as supervised learning because input data is different from output data even if input/output data is configured from a single word sequence.

A loss function in general supervised learning is defined as cross-entropy between a predicted label probability distribution and a target label probability distribution of the input data of the artificial neural network. Here, the target label probability distribution is a one-hot encoding vector, in which a correct label has a value of 1 and the remaining labels have a value of 0. For example, in a task for distinguishing between [dog, cat] in images, the target label probability distribution for a dog image is [1, 0], while the target label probability distribution for a cat image is [0, 1]. Similarly, in the case of a next word prediction task for natural language generation, assuming that V words are present, the word label probability distribution at each step is represented by a one-hot encoding vector having a size of V in which only the position of the word in the corresponding step is 1 and the positions of the words in the remaining steps are 0.

Representing the target label probability distribution by one-hot encoding vector causes two problems because a relationship between labels is regarded only as exclusive without considering similarity between the labels. First, when the label distribution of the learning data is imbalanced, that is, when some labels have a large amount of learning data and others have a small amount of learning data, a problem arises in that training is not sufficiently performed on labels in which the amount of learning data is small. This problem is frequently observed even in natural language data following Zipf's law. Second, because the predicted label probability distribution of an artificial neural network model is trained to follow the target label probability distribution, the predicted label probability distribution does not sufficiently represent relationships between labels. That is, it is difficult for humans to understand or control the predicted label probability distribution of the model.

### SUMMARY

Embodiments of the present disclosure are directed to enabling a target label probability distribution to represent features having similarity and distinction among labels through clustering, thus enhancing the supervised learning performance of an artificial neural network for labels having a small amount of data and improving the interpretability of the predicted label probability distribution of a model.

An artificial neural network training method based on clustering according to embodiments of the present disclosure may include obtaining a predicted cluster probability distribution indicating a probability that input data will belong to each of multiple cluster classes and a target cluster probability distribution indicating a probability that output data, which is a label for the input data, will belong to each of the multiple cluster classes, and training the artificial neural network to minimize a loss function including cross-entropy between the predicted cluster probability distribution and the target cluster probability distribution.

In an embodiment, the predicted cluster probability distribution may be obtained by inputting a hidden state vector, output by inputting the input data to the artificial neural network, to a predicted cluster layer, and computing the predicted cluster probability distribution by applying a Softmax function to an output vector of the predicted cluster layer. The target cluster probability distribution may be obtained by inputting the output data to a target cluster layer, and computing the predicted cluster probability distribution by applying the Softmax function to an output vector of the target cluster layer.

In an embodiment, each of the predicted cluster layer and the target cluster layer may be implemented as a feed-forward neural network having learning parameters that are differently initialized.

In an embodiment, when the hidden state vector is h, a size of the output vector of the predicted cluster layer and a size of the output vector of the target cluster layer are K, and each of the predicted cluster layer and the target cluster layer is an affine transformation layer having parameters W and b, the output vector z of the predicted cluster layer may be computed by

$$z = W h + b where z = [ {z}_{1} , {z}_{2} , … , {z}_{K} ] .$$

Further, the output vector z′ of the target cluster layer may be computed by

$${z}^{′} = {W}^{′} e + {b}^{′} where {z}^{′} = [ {z}_{1}^{′} , {z}_{2}^{′} , … , {z}_{K}^{′} ] .$$

In an embodiment, the output data may be represented by an embedding vector having a certain size. The output data may be a learnable parameter that is capable of being initialized to a value pre-trained through unsupervised learning.

In an embodiment, the loss function may include the cross-entropy between the predicted cluster probability distribution and the target cluster probability distribution, and entropy of the target cluster probability distribution.

In an embodiment, when the input data is x, the output data is y, numbers of predicted cluster probability distributions and target cluster probability distributions are N, the predicted cluster probability distribution is p, the target cluster probability distribution is q, the output vector of the predicted cluster layer is z, the output vector of the target cluster layer is z′, and β is a real number between 0 and 1, the loss function may be computed by

$$ℒ = - \frac{1}{N} {\sum }_{i = 1}^{N} {q}_{i} ( {z}^{′} \vert y ) log {p}_{i} ( z \vert x ) + β \frac{1}{N} {\sum }_{i = 1}^{N} {q}_{i} ( {z}^{′} \vert y ) log {q}_{i} ( {z}^{′} \vert y ) .$$

An artificial neural network prediction method based on clustering according to embodiments of the present disclosure may include obtaining a predicted cluster probability distribution indicating a probability that input data will belong to each of multiple cluster classes and a target cluster probability distribution indicating a probability that output data, which is a label for the input data, will belong to each of the multiple cluster classes, obtaining values at which the input data is to be classified into respective labels by computing an average of cross-entropy between the predicted cluster probability distribution and the target cluster probability distribution, and outputting a label having a smallest value among the values for all labels.

In an embodiment, the predicted cluster probability distribution may be obtained by inputting a hidden state vector, output by inputting the input data to the artificial neural network, to a predicted cluster layer, and computing the predicted cluster probability distribution by applying a Softmax function to an output vector of the predicted cluster layer. The target cluster probability distribution may be obtained by inputting the output data to a target cluster layer, and computing the predicted cluster probability distribution by applying the Softmax function to an output vector of the target cluster layer.

In an embodiment, each of the predicted cluster layer and the target cluster layer may be implemented as a feed-forward neural network.

In an embodiment, when the hidden state vector is h, a size of the output vector of the predicted cluster layer and a size of the output vector of the target cluster layer are K, and each of the predicted cluster layer and the target cluster layer is an affine transformation layer having parameters W and b, the output vector z of the predicted cluster layer may be computed by z=Wh+b where z=[Z₁, Z₂, . . . , Z_{K}], and the output vector z′ of the target cluster layer may be computed by

$${z}^{′} = {W}^{′} e + {b}^{′} where {z}^{′} = [ {z}_{1}^{′} , {z}_{2}^{′} , … , {z}_{K}^{′} ] .$$

In an embodiment, the output data may be represented by an embedding vector having a certain size. The output data may be a learnable parameter that is capable of being initialized to a value pre-trained through unsupervised learning.

In an embodiment, when the input data is x, the output data is y, the predicted cluster probability distribution is p, the target cluster probability distribution is q, numbers of predicted cluster probability distributions and target cluster probability distributions are N, a number of labels is V, an output vector of the predicted cluster layer is z, and an output vector of the target cluster layer is z′, values sⱼ at which the input data is classified into respective labels may be obtained by

$${s}_{j} = - \frac{1}{N} {\sum }_{i = 1}^{N} {q}_{i} ( {z}^{′} \vert {y}_{j} ) log p ( z \vert x ) where j = 1 , … , V .$$

In an embodiment, as the target cluster probability distribution, a previously computed value may be used.

According to the present disclosure, a problem in which the performance of an artificial neural network decreases for a small number of labels in an environment in which the distribution of labels is imbalanced may be mitigated. In addition, the distribution of labels predicted by a model can be more easily understood.

The effects of the present disclosure are not limited to those mentioned above, and other effects not explicitly stated will be clearly understood by those skilled in the art from the following description.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings:

FIG. 1 is a flowchart illustrating the operation flow of an artificial neural network training method based on clustering according to an embodiment of the present disclosure.

FIG. 2 illustrates the configuration of an artificial neural network training method based on clustering according to an embodiment of the present disclosure.

FIG. 3 is a flowchart illustrating the operation flow of an artificial neural network prediction method based on clustering according to an embodiment of the present disclosure.

### DETAILED DESCRIPTION OF THE INVENTION

The above object and other objects, advantages and features of the present disclosure, and methods for achieving the same will be cleared with reference to embodiments described later in detail together with the accompanying drawings.

However, the present disclosure is not limited to the embodiments disclosed below, and may be implemented in various other forms. The following embodiments are merely provided to enable those skilled in the art to easily understand the objects, configuration, and effects of the present disclosure. The scope of the present disclosure should be defined by the description of the accompanying claims.

Meanwhile, the terminology used in the present specification is intended solely for the purpose of describing embodiments and is not intended to limit the scope of the present disclosure. In the present specification, the singular forms also include the plural forms unless the context clearly indicates otherwise. The terms “comprises” and/or “comprising” used in the specification are merely intended to indicate that components, steps, operations, and/or elements described below are present, and do not exclude the presence or addition of one or more other components, steps, operations, and/or elements.

In the present disclosure, multiple predicted cluster probability distributions and target cluster probability distributions are constructed, and clusters are generated by minimizing the cross-entropy therebetween. The predicted cluster probability distributions and the target cluster probability distributions are used to compute the predicted labels of a model.

The scope of the present disclosure is limited to supervised learning methods for artificial neural networks, but semi-supervised learning, in which supervised learning follows unsupervised learning, is also included in the scope of the disclosure. Although the following description uses an image classification task as an example, the present disclosure is applicable to a scheme in which an artificial neural network learns input/output data in a situation in which the input/output data is given. The structure of the artificial neural network may include various architectures, such as a feedforward neural network, a recurrent neural network, a convolutional neural network, and Transformer, and may be selected as a structure suitable for the processing of the input data. The present disclosure does not have limitations on the structure of the artificial neural network.

Hereinafter, embodiments of the present disclosure will be described in detail with reference to the attached drawings.

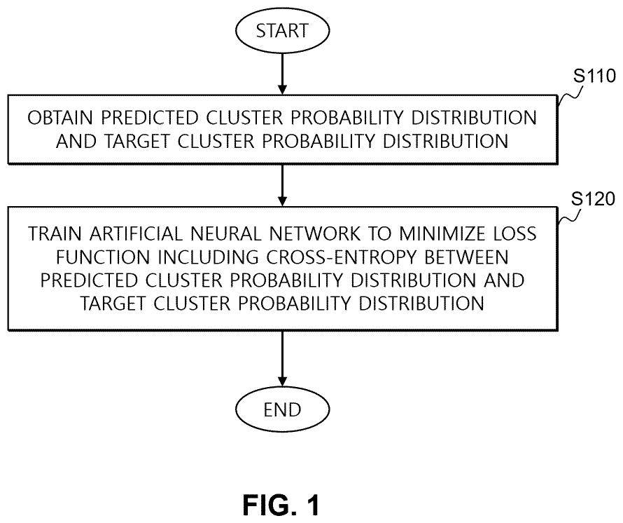

FIG. 1 is a flowchart illustrating the operation flow of an artificial neural network training method based on clustering according to an embodiment of the present disclosure.

The artificial neural network training method based on clustering according to the embodiment of the present disclosure includes the step (step S110) of obtaining a predicted cluster probability distribution indicating a probability that input data will belong to each of multiple cluster classes, and a target cluster probability distribution indicating a probability that output data, which is a label for the input data, will belong to each of the multiple cluster classes, and the step (step S120) of training the artificial neural network so as to minimize a loss function including cross-entropy between the predicted cluster probability distribution and the target cluster probability distribution.

The predicted cluster probability distribution may be obtained through the step of inputting a hidden state vector, which is output by inputting the input data to the artificial neural network, to a predicted cluster layer and the step of computing the predicted cluster probability distribution by applying a Softmax function to the output vector of the predicted cluster layer.

The target cluster probability distribution may be obtained through the step of inputting the output data to a target cluster layer, and computing the predicted cluster probability distribution by applying the Softmax function to the output vector of the target cluster layer.

The output data may be represented by an embedding vector having a certain size. The output data may be initialized to a pre-trained value through unsupervised learning, and may be a learnable parameter.

In an embodiment, the loss function may include the cross-entropy between the predicted cluster probability distribution and the target cluster probability distribution, and the entropy of the target cluster probability distribution.

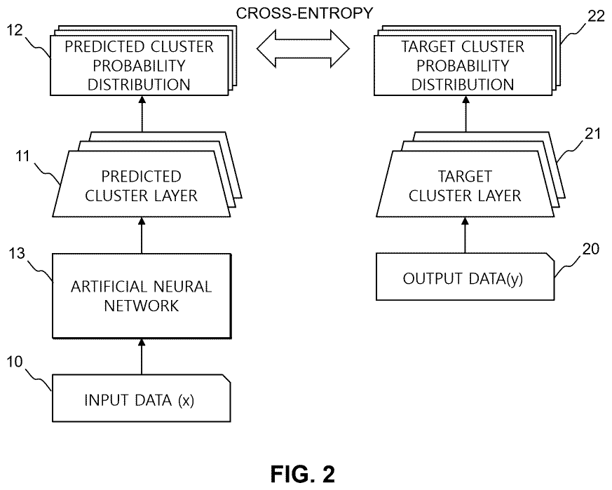

Below, operations in respective steps will be described in detail with reference to FIG. 2. FIG. 2 illustrates the configuration of an artificial neural network training method according to an embodiment of the present disclosure.

An artificial neural network 13 receives input data 10 and outputs a hidden state vector h having a certain size. The output hidden state vector h is input to predicted cluster layers 11 having a feed-forward neural network structure. There are N predicted cluster layers 11, where N is the number of clusters. Each predicted cluster layer 11 includes a learnable parameter initialized to a random value, and has an output vector z with a size of K. Here, K is the number of data cluster classes.

Taking animal image classification as an example, each label represents the type of animal, and may be [dog, cat, . . . ]. A cluster corresponds to the features of the label, and may be [fur, beak, legs, tail, . . . ], and a cluster class represents the attributes of each feature, such as [presence/absence of fur, presence/absence of a beak, number of legs is 2/4/6/ . . . , . . . ].

When the predicted cluster layers 11 are set to affine transformation layers having parameters W and b, the output vector z may be computed, as shown in the following Equation 1.

$$z = W h + b where z = [ {z}_{1} , {z}_{2} , … , {z}_{K} ] \qquad [ Equation 1 ]$$

In Equation 1, K denotes the number of data cluster classes and is a hyperparameter to be set before training.

Each of predicted cluster probability distributions 12 indicates a probability that input data (x) 10 will belong to each of K cluster classes. The predicted cluster probability distribution 12 include N predicted cluster probability distributions corresponding to the number of clusters. For example, the predicted cluster probability distribution 12 for the ‘fur’ cluster represents the probability of belonging to the ‘presence of fur’ class and the probability of belonging to the ‘absence of fur’ class. The predicted cluster probability distribution 12 for the ‘legs’ cluster may represent the probabilities of belonging to the ‘2 legs’ class, ‘4 legs’ class, ‘6 legs’ class, and the like. The predicted cluster probability distribution 12 p(z|x) may be computed by the following Equation 2 by applying a Softmax function to the output vector z of the predicted cluster layers 11.

$$p ( z \vert x ) = softmax ( z ) = \frac{exp ( {z}_{í} )}{{\sum }_{i = 1}^{K} exp ( {z}_{i} )} \qquad [ Equation 2 ]$$

When the input image is ‘dog’, fur, tail, color, and the like may be the features of the corresponding label, and thus it is desired to take into consideration multiple cluster probability distributions for each input image.

Therefore, each of the predicted cluster layers 11 that output predicted cluster probability distributions in the present disclosure may be composed of N feed-forward neural networks having different parameters, where N is an integer greater than 1, which indicates the number of clusters, and is a hyperparameter to be set before training. Accordingly, the predicted cluster probability distribution 12 includes N predicted cluster probability distributions such as p₁(z|x), . . . , p_{N}(z|x).

Output data (y) 20 may be a label for the input data (x) 10, and may be represented by an embedding vector e having a certain size. For example, [dog, cat] labels may be represented by vectors having a certain size, such as [e_{dog}, e_{cat}]. The embedding vector may be initialized to a pre-trained value through unsupervised learning such as a random value or Skip-Gram, and may be regarded as a learnable parameter.

Each of target cluster layers 21 is a feed-forward neural network that converts an input vector into a cluster probability distribution. Each of the target cluster layers 21 includes a learnable parameter initialized to a random value, and has an output vector z′ with a size of K. When each of the target cluster layers 21 is set to an affine transformation layer having parameters W′ and b′, the output vector is computed by the following Equation 3.

$${z}^{′} = {W}^{′} e + {b}^{′} where {z}^{′} = [ {z}_{1}^{′} , {z}_{2}^{′} , … , {z}_{K}^{′} ] \qquad [ Equation 3 ]$$

Each of target cluster probability distributions 22 refers to a probability that the output data will belong to each of K cluster classes. Each target cluster probability distribution q (z′|y) 22 is computed by the following Equation 4 by applying a Softmax function to the output vector z′ of the target cluster layers 21.

$$q ( {z}^{′} \vert y ) = softmax ( {z}^{′} ) = \frac{exp ( {z}_{í}^{′} )}{{\sum }_{i = 1}^{K} exp ( {z}_{í}^{′} )} \qquad [ Equation 4 ]$$

Similar to the predicted cluster probability distribution 12, the target cluster probability distribution 22 also includes N target cluster probability distributions, such as q₁ (z′|y), . . . , q_{N}(z′|y). That is, each target cluster layer 21 is composed of N feed-forward neural networks having learning parameters that are differently initialized.

In order to train the artificial neural network so that the features of input data match the features of the output data, a loss function for training the artificial neural network is defined as the cross-entropy between the predicted cluster probability distribution 12, computed from the input data, and the target cluster probability distribution 22, computed from the output data. Since this loss function has the characteristic of decreasing as the predicted cluster probability distribution 12 and the target cluster probability distribution 22 are closer to one-hot encoding, there is the possibility to allocate all data to an arbitrary cluster rather than learning an actual cluster probability distribution.

In order to prevent this, the entropy of the target cluster probability distribution may be maximized. All learning parameters in FIG. 2 are trained to minimize the loss function of Equation 5.

$$ℒ = - \frac{1}{N} {\sum }_{i = 1}^{N} {q}_{i} ( {z}^{′} \vert y ) log {p}_{i} ( z \vert x ) + β \frac{1}{N} {\sum }_{i = 1}^{N} {q}_{i} ( {z}^{′} \vert y ) log {q}_{i} ( {z}^{′} \vert y ) \qquad [ Equation 5 ]$$

The loss function of Equation 5 is composed of the cross-entropy between the predicted cluster probability distribution and the target cluster probability distribution and a value, obtained by multiplying β by the entropy of the target cluster probability distribution. β may be a hyperparameter that maintains the balance between the cross-entropy between the predicted cluster probability distribution and the target cluster probability distribution and the entropy of the target cluster probability distribution, and that is a real number equal to or greater than 0 and defined before training. When β is closer to 0, a large amount of data is concentrated on a single cluster. As β becomes larger, data is uniformly distributed in the clusters.

According to the method of the present disclosure, the target label distribution of a dog image is no longer represented by 0 and 1, but is rather represented by a distribution for features of the dog (e.g., fur, tail, legs, etc.). Therefore, when features with other labels are shared even if the number of certain labels is relatively small, the labels may be effectively learned. For example, although a small amount of data about raccoons is present, raccoons share many features with dogs or cats, and thus the data about raccoons may be learned more effectively using the method of the present disclosure. In addition, since images with similar label distributions are grouped into the same cluster, it is easy to understand the predicted label probability distribution of the model.

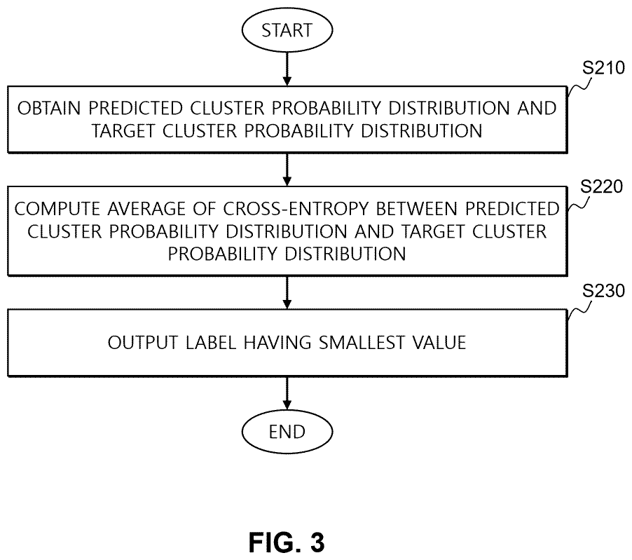

Below, an artificial neural network prediction method based on clustering according to an embodiment of the present disclosure will be described in detail with reference to FIG. 3. In an inference step of the artificial neural network, labels are predicted through a comparison between N predicted cluster probability distributions p₁(z|x), . . . , p_{N}(z|x) and target cluster probability distributions q₁(z′|y), . . . , q_{N}(z′|y).

The artificial neural network prediction method based on clustering according to the embodiment of the present disclosure may include the step (step S210) of obtaining a predicted cluster probability distribution indicating a probability that input data will belong to each of multiple cluster classes, and a target cluster probability distribution indicating a probability that output data, which is a label for the input data, will belong to each of the multiple cluster classes, the step (step S220) of obtaining values at which input data is to be classified into respective labels by computing the average of the cross-entropy between the predicted cluster probability distribution and the target cluster probability distribution, and the step (step S230) of outputting a label having the smallest value, among the values for all labels.

In step S210, the predicted cluster probability distribution of input is computed by utilizing a trained feed-forward network. Since the target cluster probability distribution is obtained from the labels, it may be computed in advance. Methods of computing the predicted cluster probability distribution and the target cluster probability distribution are identical to those when training is performed.

In step S220, values sⱼ at which the input data is to be classified into respective labels by computing the average of the cross-entropy between the predicted cluster probability distribution and target cluster probability distributions for respective labels are computed.

$${s}_{j} = - \frac{1}{N} {\sum }_{i = 1}^{N} {q}_{i} ( {z}^{′} \vert {y}_{j} ) log p ( z \vert x ) where j = 1 , … , V \qquad [ Equation 6 ]$$

In the above equation, V denotes the number of labels.

After sⱼ values are obtained for all labels, a label having the smallest value among the sⱼ values for all labels may be designated as the output of the model in step S230.

Each method according to embodiments of the present disclosure may be implemented in the form of program instructions executable through various types of computer means, and may be recorded on a computer-readable medium.

The computer-readable medium may include program instructions, data files, data structures, or the like, either alone or in combination. The program instructions recorded on the computer-readable medium may be specially designed and configured for implementing the present disclosure, or may be known and available to those skilled in the field of computer software. A computer-readable recording medium may include hardware devices configured to store and execute program instructions. For example, the computer-readable recording medium may include magnetic media such as a hard disk, a floppy disk, and magnetic tape, optical media such as CD-ROMs and DVDs, magneto-optical media such as a floptical disk, ROM, RAM, and flash memory. The program instructions may include not only machine code, such as code produced by a compiler, but also high-level language code that can be executed by a computer using an interpreter or the like.

While the embodiments of the present disclosure have been described in detail above, it should be understood that the scope of the present disclosure is not limited thereto. Various modifications and alterations made by those skilled in the art, based on the basic concept of the disclosure defined in the accompanying claims, may also fall within the scope of the present disclosure.

What is claimed is:

1. An artificial neural network training method based on clustering, comprising:
obtaining a predicted cluster probability distribution indicating a probability that input data will belong to each of multiple cluster classes and a target cluster probability distribution indicating a probability that output data, which is a label for the input data, will belong to each of the multiple cluster classes; and
training the artificial neural network to minimize a loss function including cross-entropy between the predicted cluster probability distribution and the target cluster probability distribution.

2. The artificial neural network training method as claimed in claim 1, wherein:
the predicted cluster probability distribution is obtained by:
inputting a hidden state vector, output by inputting the input data to the artificial neural network, to a predicted cluster layer, and
computing the predicted cluster probability distribution by applying a Softmax function to an output vector of the predicted cluster layer, and
the target cluster probability distribution is obtained by:
inputting the output data to a target cluster layer, and
computing the predicted cluster probability distribution by applying the Softmax function to an output vector of the target cluster layer.

3. The artificial neural network training method as claimed in claim 2, wherein each of the predicted cluster layer and the target cluster layer is implemented as a feed-forward neural network having learning parameters that are differently initialized.

4. The artificial neural network training method as claimed in claim 3, wherein, when the hidden state vector is h, a size of the output vector of the predicted cluster layer and a size of the output vector of the target cluster layer are K, and each of the predicted cluster layer and the target cluster layer is an affine transformation layer having parameters W and b,
the output vector z of the predicted cluster layer is computed by
$$z = Wh + b where z = [ {z}_{1} , {z}_{2} , … , {z}_{K} ] ,$$
and
the output vector z′ of the target cluster layer is computed by
$${z}^{′} = {W}^{′} e + {b}^{′} where {z}^{′} = [ {z}_{1}^{′} , {z}_{2}^{′} , … , {z}_{K}^{′} ] .$$

5. The artificial neural network training method as claimed in claim 1, wherein the output data is represented by an embedding vector having a certain size and is a learnable parameter that is capable of being initialized to a value pre-trained through unsupervised learning.

6. The artificial neural network training method as claimed in claim 1, wherein the loss function includes the cross-entropy between the predicted cluster probability distribution and the target cluster probability distribution, and entropy of the target cluster probability distribution.

7. The artificial neural network training method as claimed in claim 6, wherein when the input data is x, the output data is y, numbers of predicted cluster probability distributions and target cluster probability distributions are N, the predicted cluster probability distribution is p, the target cluster probability distribution is q, the output vector of the predicted cluster layer is z, the output vector of the target cluster layer is z′, and β is a real number between 0 and 1, the loss function is computed by
$$ℒ = - \frac{1}{N} {\sum }_{i = 1}^{N} {q}_{i} ( {z}^{′} \vert y ) log {p}_{i} ( z \vert x ) + β \frac{1}{N} {\sum }_{i = 1}^{N} {q}_{i} ( {z}^{′} \vert y ) log {q}_{i} ( {z}^{′} \vert y ) .$$

8. An artificial neural network prediction method based on clustering, comprising:
obtaining a predicted cluster probability distribution indicating a probability that input data will belong to each of multiple cluster classes and a target cluster probability distribution indicating a probability that output data, which is a label for the input data, will belong to each of the multiple cluster classes;
obtaining values at which the input data is to be classified into respective labels by computing an average of cross-entropy between the predicted cluster probability distribution and the target cluster probability distribution; and
outputting a label having a smallest value among the values for all labels.

9. The artificial neural network prediction method as claimed in claim 8, wherein the predicted cluster probability distribution is obtained by:
inputting a hidden state vector, output by inputting the input data to the artificial neural network, to a predicted cluster layer, and
computing the predicted cluster probability distribution by applying a Softmax function to an output vector of the predicted cluster layer, and
the target cluster probability distribution is obtained by:
inputting the output data to a target cluster layer, and
computing the predicted cluster probability distribution by applying the Softmax function to an output vector of the target cluster layer.

10. The artificial neural network prediction method as claimed in claim 9, wherein each of the predicted cluster layer and the target cluster layer is implemented as a feed-forward neural network.

11. The artificial neural network prediction method as claimed in claim 10, wherein, when the hidden state vector is h, a size of the output vector of the predicted cluster layer and a size of the output vector of the target cluster layer are K, and each of the predicted cluster layer and the target cluster layer is an affine transformation layer having parameters W and b,
the output vector z of the predicted cluster layer is computed by
$$z = Wh + b where z = [ {z}_{1} , {z}_{2} , … , {z}_{K} ] ,$$
and
the output vector z′ of the target cluster layer is computed by
$${z}^{′} = {W}^{′} e + {b}^{′} where {z}^{′} = [ {z}_{1}^{′} , {z}_{2}^{′} , … , {z}_{K}^{′} ] .$$

12. The artificial neural network prediction method as claimed in claim 8, wherein the output data is represented by an embedding vector having a certain size and is a learnable parameter that is capable of being initialized to a value pre-trained through unsupervised learning.

13. The artificial neural network prediction method as claimed in claim 8, wherein, when the input data is x, the output data is y, the predicted cluster probability distribution is p, the target cluster probability distribution is q, numbers of predicted cluster probability distributions and target cluster probability distributions are N, a number of labels is V, an output vector of the predicted cluster layer is z, and an output vector of the target cluster layer is z′,
values sⱼ at which the input data is classified into respective labels are obtained by sⱼ=−1/NΣᵢ₌₁^{N}qᵢ(z′|yⱼ)log p(z|x) where j=1, . . . , V.

14. The artificial neural network prediction method as claimed in claim 8, wherein, as the target cluster probability distribution, a previously computed value is used.
